(19) United States
(12) Patent Application Publication
(10) Pub. No.: US 2025/0207918 A1
(43) Pub. Date: Jun. 26, 2025

(54) Method Of Manufacturing Physical Quantity Detection Device, And Physical Quantity Detection Device

(71) Applicant: SEIKO EPSON CORPORATION, Tokyo (JP)

(72) Inventor: Shogo SASAKI, Matsumoto (JP)

(21) Appl. No.: 18/989,800

(22) Filed: Dec. 20, 2024

(30) Foreign Application Priority Data
Dec. 21, 2023 (JP) 2023-215555

(51) Int. Cl. G01C 19/56

(52) U.S. Cl. CPC G01C 19/56

(57) ABSTRACT

A method includes preparing a vibration element, adjusting at least one of drive vibration arms, and electrically coupling a first detection electrode and a third detection electrode and electrically coupling a second detection electrode and a fourth detection electrode.

The present application is based on, and claims priority from JP Application Serial Number 2023-215555, filed Dec. 21, 2023, the disclosure of which is hereby incorporated by reference herein in its entirety.

### BACKGROUND

### 1. Technical Field

The present disclosure relates to a method of manufacturing a physical quantity detection device, and a physical quantity detection device.

### 2. Related Art

JP-A-2015-184124 discloses a physical quantity detection device, that is, a gyro sensor in which detection sensitivity is improved by receiving a charge amount from both positive and negative electrodes without grounding one of the positive and negative electrodes of a detection arm.

However, in the configuration described in JP-A-2015-184124, a first detection electrode and a fourth detection electrode are electrically coupled to each other, a second detection electrode and a third detection electrode are electrically coupled to each other, and it is not known from which detection vibration arm an unnecessary signal is generated. Therefore, there is a problem in that appropriate balance tuning cannot be achieved. Accordingly, there is a problem that a performance of the gyro sensor varies.

### SUMMARY

In a method of manufacturing a physical quantity detection device, the physical quantity detection device includes a physical quantity detection element including a base portion and a plurality of vibration arms coupled to the base portion, a detection circuit configured to detect detection vibration generated in the physical quantity detection element, and a drive circuit configured to drive the vibration arms to vibrate. The vibration arms includes: a first drive vibration arm having a first weight portion at a tip end; a second drive vibration arm having a second weight portion at a tip end; a first detection vibration arm including a first detection electrode and a second detection electrode; and a second detection vibration arm including a third detection electrode decoupled from both the first detection electrode and the second detection electrode, and a fourth detection electrode decoupled from both the first detection electrode and the second detection electrode. The method includes: preparing the physical quantity detection element; adjusting at least one of the first drive vibration arm and the second drive vibration arm; and electrically coupling the first detection electrode and the third detection electrode and electrically coupling the second detection electrode and the fourth detection electrode.

A physical quantity detection device includes: a physical quantity detection element including a base portion and a plurality of vibration arms coupled to the base portion; a detection circuit configured to detect detection vibration generated in the physical quantity detection element; and a drive circuit configured to drive the vibration arms to vibrate. The vibration arms includes a first drive vibration arm having a first weight portion at a tip end, a second drive vibration arm having a second weight portion at a tip end, a first detection vibration arm including a first detection electrode and a second detection electrode, and a second detection vibration arm including a third detection electrode and a fourth detection electrode. The first detection electrode and the third detection electrode are electrically coupled to each other by a first conductive member. The second detection electrode and the fourth detection electrode are electrically coupled to each other by a second conductive member. At least one of the first weight portion and the second weight portion is formed with a processing mark recessed in a thickness direction.

### BRIEF DESCRIPTION OF THE DRAWINGS

FIG. 1 is a block diagram showing a configuration of a physical quantity detection device.

FIG. 2 is a plan view showing a configuration of a vibration element as a physical quantity detection element.

FIG. 3 is an enlarged plan view of a part A of the vibration element shown in FIG. 2.

FIG. 4 is a cross-sectional view taken along a line B-B and a line C-C of the vibration element shown in FIG. 2.

FIG. 5A is a schematic diagram showing an operation of the vibration element.

FIG. 5B is a schematic diagram showing an operation of the vibration element.

FIG. 6A is a diagram showing an example of a signal waveform in a detection mode.

FIG. 6B is a diagram showing an example of the signal waveform in the detection mode.

FIG. 6C is a diagram showing an example of the signal waveform in the detection mode.

FIG. 6D is a diagram showing an example of the signal waveform in the detection mode.

FIG. 6E is a diagram showing an example of the signal waveform in the detection mode.

FIG. 6F is a diagram showing an example of the signal waveform in the detection mode.

FIG. 7 is a flowchart showing a method of manufacturing the physical quantity detection device.

FIG. 8 is a plan view showing a part of the method of manufacturing the physical quantity detection device.

FIG. 9 is a plan view showing a part of the method of manufacturing the physical quantity detection device.

FIG. 10 is a plan view showing a configuration of a vibration element according to a modification.

FIG. 11 is a cross-sectional view taken along a line D-D of the vibration element according to the modification shown in FIG. 10.

FIG. 12 is a plan view showing the configuration of the vibration element according to the modification.

### DESCRIPTION OF EMBODIMENTS

In the following drawings, three axes orthogonal to one another will be described as an X-axis, a Y-axis, and a Z-axis. A direction along the X-axis is an “X-direction”, a direction along the Y-axis is a “Y-direction”, a direction along the Z-axis is a “Z-direction”, a direction of an arrow is a +direction, and a direction opposite to the +direction is a −direction. A thickness direction of a vibration element 100, that is, a plan view from the Z-axis direction is also simply referred to as a “plan view”.

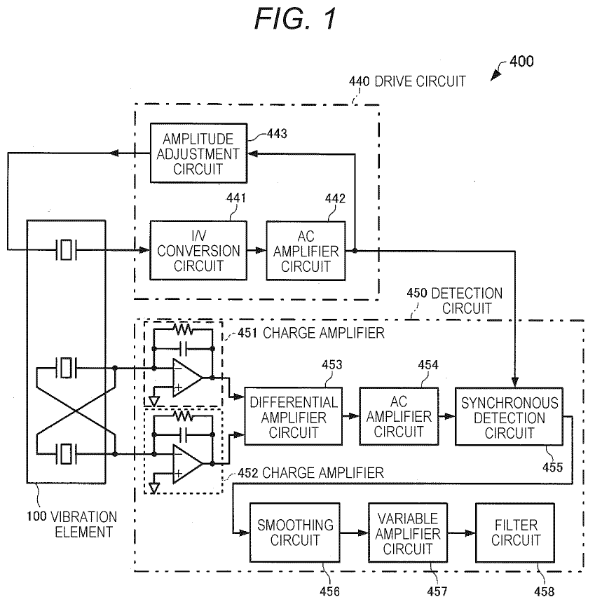

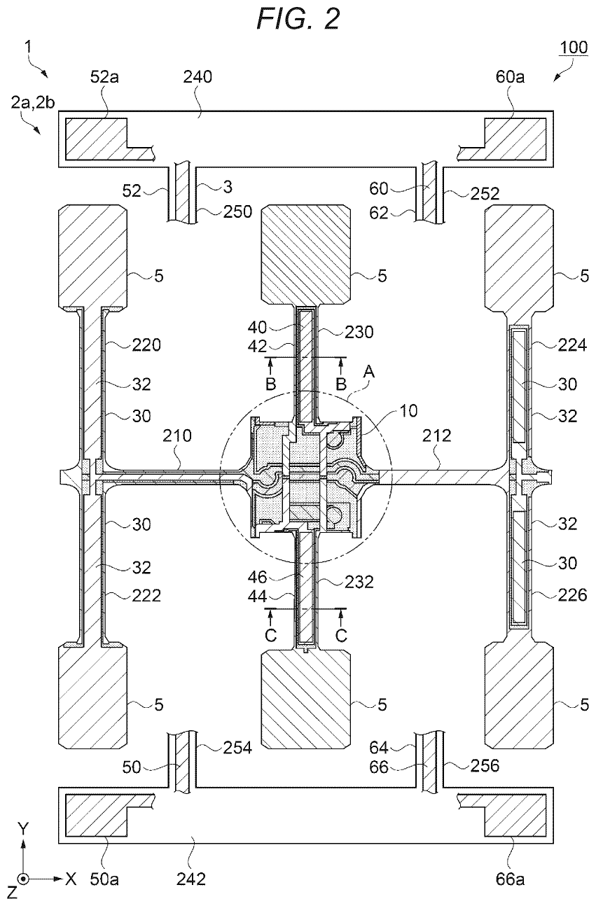

As shown in FIG. 1, a physical quantity detection device 400 includes the vibration element 100 as a physical quantity detection element, a drive circuit 440 for driving and vibrating drive vibration arms 220, 222, 224, and 226 (see FIG. 2) of the vibration element 100, and a detection circuit 450 for detecting detection vibration generated in detection vibration arms 230 and 232 of the vibration element 100 when an angular velocity is applied. The drive circuit 440 and the detection circuit 450 may be implemented by a one-chip IC, or may be implemented by separate IC chips.

The drive circuit 440 includes an I/V conversion circuit (current-voltage conversion circuit) 441, an AC amplifier circuit 442, and an amplitude adjustment circuit 443. The drive circuit 440 is a circuit that outputs a signal for driving the drive vibration arms 220, 222, 224, and 226 to drive input electrodes 30 (see FIG. 2) of the vibration element 100 and receives a signal output from drive output electrodes 32 (see FIG. 2) of the vibration element 100.

When the drive vibration arms 220, 222, 224, and 226 of the vibration element 100 vibrate, an alternating current based on a piezoelectric effect is output from the drive output electrodes 32 and input to the I/V conversion circuit 441. The I/V conversion circuit 441 converts the received alternating current into an alternating voltage signal having the same frequency as a vibration frequency of the drive vibration arms 220, 222, 224, and 226, and outputs the alternating voltage signal.

The alternating voltage signal output from the I/V conversion circuit 441 is input to the AC amplifier circuit 442. The AC amplifier circuit 442 amplifies and outputs the received alternating voltage signal.

The alternating voltage signal output from the AC amplifier circuit 442 is input to the amplitude adjustment circuit 443. The amplitude adjustment circuit 443 controls a gain to keep an amplitude of the received alternating voltage signal at a constant value, and outputs the alternating voltage signal after the gain control to the drive input electrodes 30 of the vibration element 100. The drive vibration arms 220, 222, 224, and 226 vibrate based on the alternating voltage signal (drive signal) input to the drive input electrodes 30.

The detection circuit 450 includes a charge amplifier 451 as a first amplifier, a charge amplifier 452 as a second amplifier, a differential amplifier circuit 453, an AC amplifier circuit 454, a synchronous detection circuit 455, a smoothing circuit 456, a variable amplifier circuit 457, and a filter circuit 458.

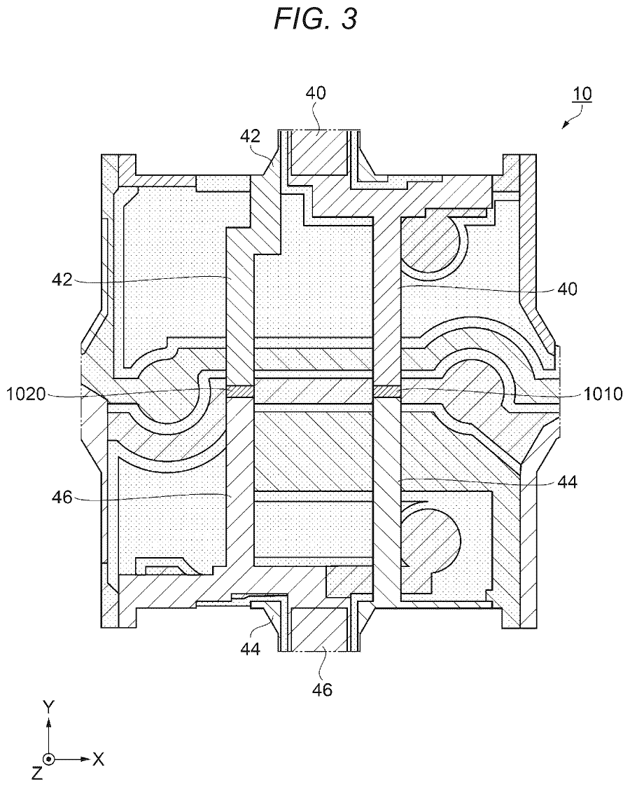

The detection circuit 450 is a circuit that detects the angular velocity based on signals output from a first detection electrode 40, a second detection electrode 42, a third detection electrode 44, and a fourth detection electrode 46 (see FIGS. 2 and 3) of the vibration element 100.

The charge amplifier 451 includes an operational amplifier, a feedback resistor, and a feedback capacitor. A first detection signal (alternating current) output from the first detection electrode 40 and a third detection signal (alternating current) output from the third detection electrode 44 are input to an inverting input terminal (−terminal) of the operational amplifier. A non-inverting input terminal (+terminal) of the operational amplifier is fixed to a reference potential. The first detection signal and the third detection signal are signals that have the same electrical polarity. The charge amplifier 451 converts, into an alternating voltage signal, the first detection signal (alternating current) and the third detection signal (alternating current) which are input to the operational amplifier.

The charge amplifier 452 includes an operational amplifier, a feedback resistor, and a feedback capacitor. A second detection signal (alternating current) output from the second detection electrode 42 and a fourth detection signal (alternating current) output from the fourth detection electrode 46 are input to an inverting input terminal (-terminal) of the operational amplifier. A non-inverting input terminal (+terminal) of the operational amplifier is fixed to a reference potential. The second detection signal and the fourth detection signal are signals that have the same electrical polarity. The charge amplifier 452 converts, into an alternating voltage signal, the second detection signal (alternating current) and the fourth detection signal (alternating current) which are input to the operational amplifier.

An electrical characteristic of the first detection signal and the third detection signal is opposite to an electrical characteristic of the second detection signal and the fourth detection signal. An output signal of the charge amplifier 451 and an output signal of the charge amplifier 452 are input to the differential amplifier circuit 453.

The differential amplifier circuit 453 functions as a differential amplification unit that differentially amplifies an output signal of the vibration element 100. The differential amplifier circuit 453 outputs a signal obtained by amplifying (differentially amplifying) a potential difference between the output signal of the charge amplifier 451 and the output signal of the charge amplifier 452. An output signal of the differential amplifier circuit 453 is input to the AC amplifier circuit 454.

The AC amplifier circuit 454 functions as an AC amplification unit that amplifies an AC signal, and outputs a signal obtained by amplifying the output signal of the differential amplifier circuit 453. An output signal of the AC amplifier circuit 454 is input to the synchronous detection circuit 455.

The synchronous detection circuit 455 extracts an angular velocity component by synchronously detecting the output signal of the AC amplifier circuit 454 based on the alternating voltage signal output from the AC amplifier circuit 442 of the drive circuit 440. A signal of the angular velocity component extracted by the synchronous detection circuit 455 is smoothed into a direct voltage signal by the smoothing circuit 456, and input to the variable amplifier circuit 457.

The variable amplifier circuit 457 amplifies (or attenuates) the output signal (direct voltage signal) of the smoothing circuit 456 with a set amplification factor (or attenuation factor), and changes angular velocity sensitivity. The signal amplified (or attenuated) by the variable amplifier circuit 457 is input to the filter circuit 458.

The filter circuit 458 removes, from the output signal of the variable amplifier circuit 457, a high-frequency noise component outside a sensor band (accurately attenuates the high-frequency noise component to a predetermined level or lower), and outputs a detection signal of a polarity and a voltage level corresponding to a direction and a magnitude of the angular velocity. The detection signal is output to the outside from an external output terminal (not shown).

In the physical quantity detection device 400 of FIG. 1, a configuration example of an analog gyro sensor that outputs the detected angular velocity with an analog voltage (DC voltage) is shown, but the embodiment is not limited thereto. For example, instead of the smoothing circuit 456, the variable amplifier circuit 457, and the filter circuit 458 in the subsequent stage of the synchronous detection circuit 455, by providing an A/D conversion circuit and a digital signal processing unit (DSP unit), a digital gyro sensor that outputs the detected angular velocity as digital data may be used. In this case, the A/D conversion circuit performs A/D conversion of a signal after synchronous detection to output a digital signal. The DSP unit performs digital signal processing such as digital filter processing and digital correction processing on the digital signal from the A/D conversion circuit, and outputs a digital signal corresponding to the detected angular velocity. Further, a filter unit such as a low-pass filter may be provided between the synchronous detection circuit 455 and the A/D conversion circuit. The filter unit has a function as a front filter of the A/D conversion circuit and a function of attenuating unnecessary signals that are not removed by the synchronous detection circuit.

Next, the configuration of the vibration element 100 will be described with reference to FIGS. 2 and 3.

As shown in FIG. 2, the vibration element 100 includes a base portion 10, coupling arms 210 and 212, the drive vibration arms 220, 222, 224, and 226, and the detection vibration arms 230 and 232. The vibration element 100 includes support portions 240 and 242, beam portions 250, 252, 254, and 256, the drive input electrodes 30, the drive output electrodes 32, the first detection electrode 40, the second detection electrode 42, the third detection electrode 44, and the fourth detection electrode 46. The vibration element 100 includes a drive input wiring 50, a drive output wiring 52, a first detection wiring 60, a second detection wiring 62, a third detection wiring 64, and a fourth detection wiring 66.

The base portion 10, the coupling arms 210 and 212, the drive vibration arms 220, 222, 224 and 226, the detection vibration arms 230 and 232, the support portions 240 and 242, and the beam portions 250, 252, 254 and 256 constitute a vibrator element 1.

A material of the vibrator element 1 is, for example, a piezoelectric material such as quartz crystal, lithium tantalate, or lithium niobate. The vibrator element 1 has a first principal surface 2a and a second principal surface 2b facing opposite directions, and a side surface 3 coupled to the principal surfaces 2a and 2b. In the illustrated example, the first principal surface 2a is a surface facing a +Z-axis direction, the second principal surface 2b is a surface facing a −Z-axis direction, and the side surface 3 is a surface orthogonal to the Z-axis. The principal surfaces 2a and 2b are, for example, flat surfaces. A thickness (a size in the Z-axis direction) of the vibrator element 1 is, for example, about 100 μm.

A planar shape of the base portion 10 is, for example, a rectangular shape (substantially rectangular shape). The first coupling arm 210 and the second coupling arm 212 extend from the base portion 10 in opposite directions along the X-axis. In the illustrated example, the first coupling arm 210 extends in a −X-axis direction from the base portion 10. The second coupling arm 212 extends in a +X-axis direction from the base portion 10.

The drive vibration arms 220 and 222 as first drive vibration arms extend from the first coupling arm 210 in opposite directions along the Y-axis. In the illustrated example, the drive vibration arm 220 extends in a +Y-axis direction from the first coupling arm 210. The drive vibration arm 222 extends in a −Y-axis direction from the first coupling arm 210. The drive vibration arms 220 and 222 are coupled to the base portion 10 through the first coupling arm 210.

The drive vibration arms 224 and 226 as second drive vibration arms extend from the second coupling arm 212 in opposite directions along the Y-axis. In the illustrated example, the drive vibration arm 224 extends in the +Y-axis direction from the second coupling arm 212. The drive vibration arm 226 extends in the −Y-axis direction from the second coupling arm 212. The drive vibration arms 224 and 226 are coupled to the base portion 10 through the second coupling arm 212.

The first detection vibration arm 230 and the second detection vibration arm 232 extend from the base portion 10 in opposite directions along the Y-axis. In the illustrated example, the first detection vibration arm 230 extends in the +Y-axis direction from the base portion 10. The second detection vibration arm 232 extends in the −Y-axis direction from the base portion 10. The detection vibration arms 230 and 232 are coupled to the base portion 10.

Wide-width portions 5 are provided at the tip ends of the vibration arms 220, 222, 224, 226, 230, and 232. The wide-width portion 5 has a width (a size in the X-axis direction) larger than widths of the other portions of the vibration arms 220, 222, 224, 226, 230, and 232. Although not shown, the wide-width portion 5 is provided with a weight portion. By adjusting a mass of the weight portion, a frequency of vibration of the vibration arms 220, 222, 224, 226, 230, and 232 can be adjusted.

The first support portion 240 is provided at the +Y-axis direction side of the vibration arms 220, 224, and 230. The second support portion 242 is provided at the −Y-axis direction side of the vibration arms 222, 226, and 232. The support portions 240 and 242 are portions fixed to a package when the vibration element 100 is mounted. The support portions 240 and 242 support the base portion 10 through the beam portions 250, 252, 254 and 256.

The first beam portion 250 and the second beam portion 252 couple the base portion 10 and the first support portion 240. In the illustrated example, the first beam portion 250 extends from the base portion 10 to the first support portion 240 through a space between the drive vibration arm 220 and the first detection vibration arm 230. The second beam portion 252 extends from the base portion 10 to the first support portion 240 through a space between the drive vibration arm 224 and the first detection vibration arm 230.

The third beam portion 254 and the fourth beam portion 256 couple the base portion 10 and the second support portion 242. In the illustrated example, the third beam portion 254 extends from the base portion 10 to the second support portion 242 through a space between the drive vibration arm 222 and the second detection vibration arm 232. The fourth beam portion 256 extends from the base portion 10 to the second support portion 242 through a space between the drive vibration arm 226 and the second detection vibration arm 232.

In the vibration element 100 according to the embodiment, as shown in FIG. 2, the vibrator element 1 is a so-called double T-type vibrator element.

As the drive input electrodes 30, the drive output electrodes 32, the first detection electrode 40, the second detection electrode 42, the third detection electrode 44, the fourth detection electrode 46, the drive input wiring 50, the drive output wiring 52, the first detection wiring 60, the second detection wiring 62, the third detection wiring 64, and the fourth detection wiring 66, for example, those in which chromium and gold are stacked in this order from the vibrator element 1 side are used.

The drive input electrodes 30 are provided at the drive vibration arms 220, 222, 224, and 226. In the illustrated example, the drive input electrodes 30 are provided at the side surface 3 of the drive vibration arm 220, the side surface 3 of the drive vibration arm 222, the side surface 3 of the coupling arms 210 and 212, the principal surfaces 2a and 2b of the drive vibration arm 224, and the principal surfaces 2a and 2b of the drive vibration arm 226. The drive input electrodes 30 are electrodes to which a signal (drive signal) for driving the drive vibration arms 220, 222, 224, and 226 is input.

The drive output electrodes 32 are provided at the principal surfaces 2a and 2b of the drive vibration arm 220, the principal surfaces 2a and 2b of the drive vibration arm 222, the side surface 3 of the drive vibration arm 224, and the side surface 3 of the drive vibration arm 226. The drive output electrodes 32 are electrodes for outputting a signal based on bending of the drive vibration arms 220, 222, 224, and 226.

The drive output electrode 32 may be provided at a position where the drive input electrode 30 is provided, or the drive input electrode 30 may be provided at a position where the drive output electrode 32 is provided.

The first detection electrode 40 is provided at the first detection vibration arm 230. In the illustrated example, the first detection electrode 40 is provided at the principal surfaces 2a and 2b of the first detection vibration arm 230. The first detection electrode 40 is an electrode for detecting a signal (first detection signal) based on bending of the first detection vibration arm 230 due to the Coriolis force.

The second detection electrode 42 is provided at the first detection vibration arm 230. In the illustrated example, the second detection electrode 42 is provided at the side surface 3 and the wide-width portion 5 of the first detection vibration arm 230. The second detection electrode 42 is an electrode for detecting a signal (second detection signal) based on the bending of the first detection vibration arm 230 due to the Coriolis force.

The third detection electrode 44 is provided at the second detection vibration arm 232. In the illustrated example, the third detection electrode 44 is provided at the side surface 3 and the wide-width portion 5 of the second detection vibration arm 232. The third detection electrode 44 is an electrode for detecting a signal (third detection signal) based on bending of the second detection vibration arm 232 due to the Coriolis force.

The fourth detection electrode 46 is provided at the second detection vibration arm 232. In the illustrated example, the fourth detection electrode 46 is provided at the principal surfaces 2a and 2b of the second detection vibration arm 232. The fourth detection electrode 46 is an electrode for detecting a signal (fourth detection signal) based on the bending of the second detection vibration arm 232 due to the Coriolis force.

Although not shown, the drive input wiring 50 is provided in the base portion 10, the coupling arms 210 and 212, the second support portion 242, and the third beam portion 254. The drive input electrodes 30 provided at the vibration arms 220, 222, 224, and 226 are electrically coupled to one another by the drive input wiring 50. The drive input wiring 50 provided in the second support portion 242 is a terminal portion 50a. The terminal portion 50a is coupled to an external member (for example, a bonding wire). The drive signal output from the drive circuit 440 is input to the drive input electrode 30 through the external member and the drive input wiring 50.

The drive output wiring 52 is provided in the base portion 10, the coupling arms 210 and 212, the first support portion 240, and the first beam portion 250. The drive output electrodes 32 provided at the vibration arms 220, 222, 224, and 226 are electrically coupled to one another by the drive output wiring 52. The drive output wiring 52 provided in the first support portion 240 is a terminal portion 52a. The terminal portion 52a is coupled to an external member (for example, a bonding wire). A signal output from the drive output electrode 32 is input to the drive circuit 440 through the drive output wiring 52 and the external member.

The first detection wiring 60 is provided in the base portion 10, the first support portion 240, and the second beam portion 252. The first detection wiring 60 is coupled to the first detection electrode 40. The first detection wiring 60 provided in the first support portion 240 is a terminal portion 60a. The terminal portion 60a is coupled to an external member (for example, a bonding wire). The first detection signal output from the first detection electrode 40 is input to the charge amplifier 451 of the detection circuit 450 through the first detection wiring 60 and the external member.

The second detection wiring 62 is provided in the base portion 10, the first support portion 240, and the second beam portion 252. The second detection wiring 62 is coupled to the second detection electrode 42. The second detection wiring 62 provided in the first support portion 240 is a terminal portion 62a. The terminal portion 62a is coupled to an external member (for example, a bonding wire). The second detection signal output from the second detection electrode 42 is input to the charge amplifier 452 of the detection circuit 450 through the second detection wiring 62 and the external member.

The third detection wiring 64 is provided in the base portion 10, the second support portion 242, and the fourth beam portion 256. The third detection wiring 64 is coupled to the third detection electrode 44. The third detection wiring 64 provided in the second support portion 242 is a terminal portion 64a. The terminal portion 64a is coupled to an external member (for example, a bonding wire). The third detection signal output from the third detection electrode 44 is input to the charge amplifier 451 of the detection circuit 450 through the third detection wiring 64 and the external member.

The fourth detection wiring 66 is provided in the base portion 10, the second support portion 242, and the fourth beam portion 256. The fourth detection wiring 66 is coupled to the fourth detection electrode 46. The fourth detection wiring 66 provided in the second support portion 242 is a terminal portion 66a. The terminal portion 66a is coupled to an external member (for example, a bonding wire). The fourth detection signal output from the fourth detection electrode 46 is input to the charge amplifier 452 of the detection circuit 450 through the fourth detection wiring 66 and the external member.

As shown in FIG. 3, the first detection electrode 40 and the third detection electrode 44 are electrically coupled to each other by a first conductive member 1010. The second detection electrode 42 and the fourth detection electrode 46 are electrically coupled to each other by a second conductive member 1020.

Before the first conductive member 1010 is formed, the first detection electrode 40 and the third detection electrode 44 are decoupled. Before the second conductive member 1020 is formed, the second detection electrode 42 and the fourth detection electrode 46 are decoupled.

That is, since the third detection electrode 44 and the fourth detection electrode 46 are decoupled from both the first detection electrode 40 and the second detection electrode 42, the detection vibration of the two detection vibration arms 230 and 232 can be individually detected, in other words, can be measured. Accordingly, the adjustment, that is, the balance tuning of the drive vibration arms 220, 222, 224, and 226 can be appropriately Accordingly, it is possible to prevent a performed. variation in a performance of the physical quantity detection device 400.

After the balance tuning, the first detection electrode 40 and the third detection electrode 44 are electrically coupled to each other by the first conductive member 1010, and the second detection electrode 42 and the fourth detection electrode 46 are electrically coupled to each other by the second conductive member 1020, a charge amount (current amount) input to the detection circuit 450 increases, and thus the element sensitivity (detection sensitivity of the angular velocity) of the vibration element 100 can be improved.

Accordingly, an S/N of an output signal of the detection circuit 450 is improved, and noise reduction can be achieved. As the element sensitivity increases, a temperature characteristic of the output signal of the detection circuit 450 also becomes relatively small. Accordingly, the physical quantity detection device 400 capable of improving a vibration characteristic can be provided.

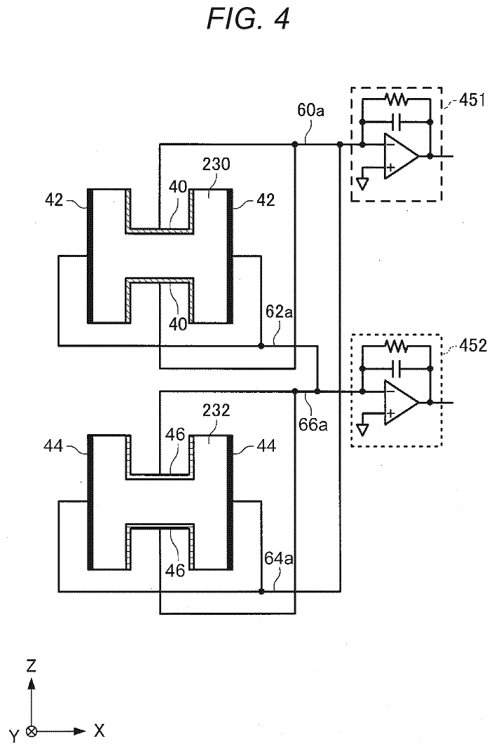

Next, a coupling configuration between the vibration element 100 and the charge amplifiers 451 and 452 will be described with reference to FIG. 4. The upper diagram of FIG. 4 is a cross-sectional view taken along a line B-B of the vibration element 100 of FIG. 2, and the lower diagram of FIG. 4 is a cross-sectional view taken along a line C-C of the vibration element of FIG. 2.

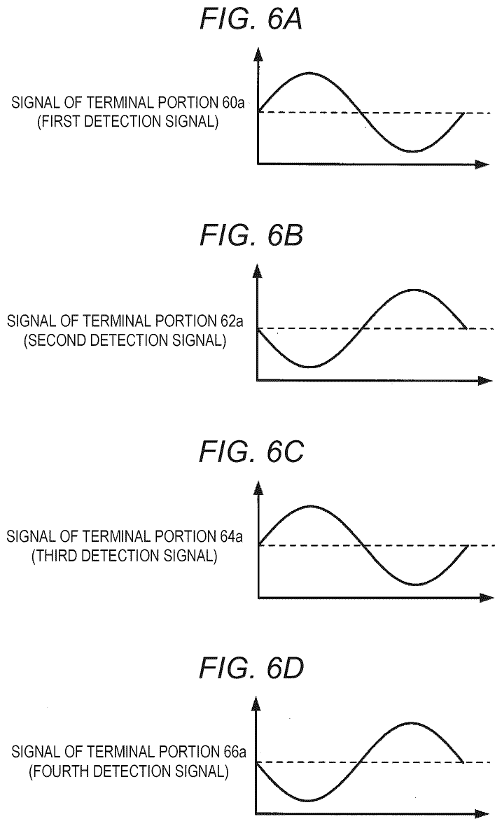

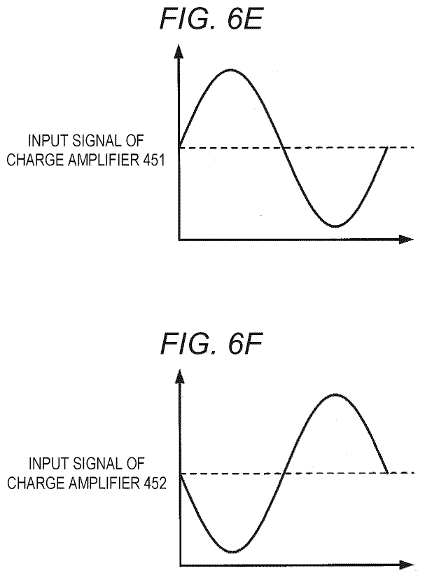

A signal waveform in a detection mode will be described with reference to FIGS. 6A to 6F. FIG. 6A is a signal waveform of the first detection signal output from the terminal portion 60a. FIG. 6B is a signal waveform of the second detection signal output from the terminal portion 62a. FIG. 6C is a signal waveform of the third detection signal output from the terminal portion 64a. FIG. 6D is a signal waveform of the fourth detection signal output from the terminal portion 66a. FIG. 6E is a signal waveform of an input signal of the charge amplifier 451, that is, a sum signal of the first detection signal and the third detection signal. FIG. 6F is a signal waveform of an input signal of the charge amplifier 452, that is, a sum signal of the second detection signal and the fourth detection signal.

As shown in FIG. 4, groove portions are provided in the principal surfaces 2a and 2b of the vibration arms 230 and 232. The electrodes 40 and 46 are provided in the groove portions. Although not shown, the principal surfaces 2a and 2b of the vibration arms 220, 222, 224 and 226 may be provided with groove portions. The electrodes 30 and 32 may be provided in the groove portions.

In the physical quantity detection device 400, both the terminal portion 60a and the terminal portion 64a of the vibration element 100 are coupled to the inverting input terminal (−terminal) of the operational amplifier provided in the charge amplifier 451.

As shown in FIGS. 6A to 6F, the input signal of the charge amplifier 451 is a signal obtained by adding the first detection signal and the third detection signal. The first detection signal and the third detection signal are signals having the same electrical polarity (the same phase). An amplitude of the input signal of the charge amplifier 451 is substantially equal to a sum of the amplitude of the first detection signal and the amplitude of the third detection signal.

Similarly, the terminal portion 62a and the terminal portion 66a of the vibration element 100 are coupled to the inverting input terminal (−terminal) of the operational amplifier provided in the charge amplifier 452.

The input signal of the charge amplifier 452 is a signal obtained by adding the second detection signal and the fourth detection signal. Since the second detection signal and the fourth detection signal are signals having the same electrical polarity (the same phase), an amplitude of the input signal of the charge amplifier 452 is substantially equal to a sum of an amplitude of the second detection signal and an amplitude of the fourth detection signal.

The sum signal of the first detection signal and the third detection signal (that is, the input signal of the charge amplifier 451) and the sum signal of the second detection signal and the fourth detection signal (that is, the input signal of the charge amplifier 452) have opposite electrical polarities (reverse phase).

According to the physical quantity detection device 400 of the embodiment, as compared with the physical quantity detection device in the related art, when the vibration element 100 detects the same angular velocity, the charge amount (current amount) input to the detection circuit 450 increases, and thus the element sensitivity (detection sensitivity of angular velocity) of the vibration element 100 is improved.

Accordingly, the S/N of the output signal of the detection circuit 450 is improved, and the noise reduction can be achieved. As the element sensitivity increases, the temperature characteristic of the output signal of the detection circuit 450 also becomes relatively small. Accordingly, according to the embodiment, it is possible to implement a highly accurate and highly stable physical quantity detection device 400.

Since the first detection electrode 40 and the third detection electrode 44 are coupled to the inverting input terminal (−terminal) of the operational amplifier provided in the charge amplifier 451, the first detection electrode 40 and the third detection electrode 44 are virtually short-circuited to the non-inverting input terminal (+terminal) of the operational amplifier and are constantly at the reference potential.

Similarly, since the second detection electrode 42 and the fourth detection electrode 46 are coupled to the inverting input terminal (−terminal) of the operational amplifier provided in the charge amplifier 452, the second detection electrode 42 and the fourth detection electrode 46 are virtually short-circuited to the non-inverting input terminal (+terminal) of the operational amplifier and are constantly at the reference potential.

That is, in the embodiment, the first detection electrode 40, the second detection electrode 42, the third detection electrode 44, and the fourth detection electrode 46 are constantly at the same potential, and no electric field is generated between the electrodes.

The drive vibration arms 220, 222, 224, and 226 have a resonance frequency fdr determined by a length, a thickness, a material, and the like thereof. The detection vibration arms 230 and 232 have a resonance frequency fdt determined by a length, a thickness, a material, and the like thereof. A difference between the resonance frequencies fdr and fdt is called a detuning frequency.

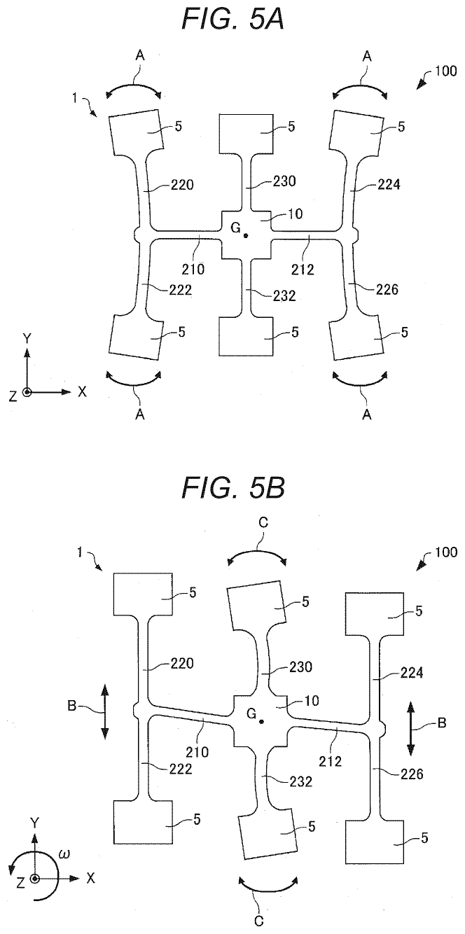

Next, an operation of the vibration element 100 will be described with reference to FIGS. 5A and 5B. In FIGS. 5A and 5B, members other than the base portion 10, the coupling arms 210 and 212, and the vibration arms 220, 222, 224, 226, 230, and 232 are not shown.

As shown in FIG. 5A, when a predetermined alternating voltage is applied to the drive input electrodes 30 provided at the drive vibration arms 220, 222, 224, and 226 in a state where the angular velocity is not applied, the vibration element 100 performs bending vibration in a direction of an arrow A in an XY plane. At this time, the drive vibration arms 220 and 222 and the drive vibration arms 224 and 226 vibrate plane-symmetrically with respect to a plane passing through a center point G and parallel to a YZ plane. Therefore, the base portion 10, the coupling arms 210 and 212, and the detection vibration arms 230 and 232 hardly vibrate.

In a state where the drive vibration arms 220, 222, 224, and 226 perform such drive vibration, as shown in FIG. 5B, when an angular velocity ω about the Z-axis is applied to the vibration element 100, the Coriolis force acts on the drive vibration arms 220, 222, 224, and 226. Accordingly, the drive vibration arms 220, 222, 224, and 226 vibrate in a direction of an arrow B. The vibration in the direction of the arrow B is circumferential vibration with respect to the center point G.

The coupling arms 210 and 212 vibrate in the direction of the arrow B by the vibration of the drive vibration arms 220, 222, 224, and 226. The vibration is transmitted to the detection vibration arms 230 and 232 through the base portion 10, so that the detection vibration arms 230 and 232 vibrate as indicated by an arrow C. The vibration in the direction of the arrow C is circumferential vibration with respect to the center point G in a direction opposite to the direction of the arrow B.

By the bending vibration of the detection vibration arms 230 and 232, the first detection signal, the second detection signal, the third detection signal, and the fourth detection signal are respectively generated in the first detection electrode 40, the second detection electrode 42, the third detection electrode 44, and the fourth detection electrode 46.

At this time, the electrical polarity of the first detection signal and the electrical polarity of the second detection signal are opposite, and the electrical polarity of the third detection signal and the electrical polarity of the fourth detection signal are opposite. The electrical polarity of the first detection signal is the same as the electrical polarity of the third detection signal, and the electrical polarity of the second detection signal is the same as the electrical polarity of the fourth detection signal.

For example, when positive charges δ+ are generated in the first detection electrode 40 and the third detection electrode 44, negative charges δ− are generated in the second detection electrode 42 and the fourth detection electrode 46. When the negative charges δ− are generated in the first detection electrode 40 and the third detection electrode 44, the positive charges δ+ are generated in the second detection electrode 42 and the fourth detection electrode 46.

The first detection signal, the second detection signal, the third detection signal, and the fourth detection signal are respectively output to the detection circuit 450 from the terminal portion 60a, the terminal portion 62a, the terminal portion 64a, and the terminal portion 66a. The detection circuit 450 can obtain the angular velocity about the Z-axis based on the detection signals.

Hereinafter, a state where the angular velocity is not detected as shown in FIG. 5A is referred to as a “drive mode”, and a state where the angular velocity is detected as shown in FIG. 5B is referred to as a “detection mode”.

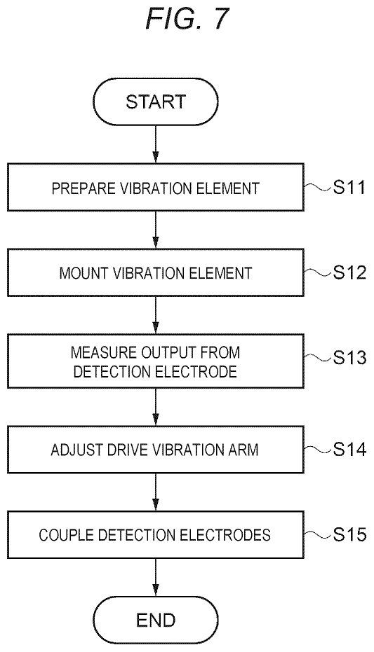

Next, a method of manufacturing the physical quantity detection device 400 will be described with reference to FIGS. 7 to 9.

As shown in FIG. 7, in step S11 (first step), the vibration element 100 as a physical quantity detection element is prepared. As shown in FIG. 3, in the vibration element 100, the first detection electrode 40, the second detection electrode 42, the third detection electrode 44, and the fourth detection electrode 46 are formed at the base portion 10.

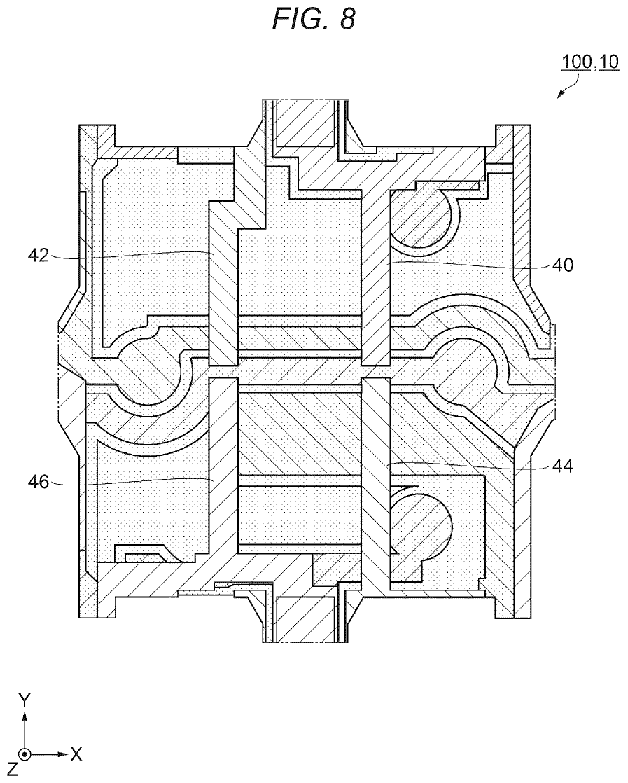

As shown in FIG. 8, the third detection electrode 44 is decoupled from both the first detection electrode 40 and the second detection electrode 42. Similarly, the fourth detection electrode 46 is decoupled from both the first detection electrode 40 and the second detection electrode 42.

In step S12, the vibration element 100 is mounted on the package (not shown). Specifically, the support portions 240 and 242 of the vibration element 100 are fixed to the package. The disclosure is not limited to the package, and may be mounted on a support substrate or a relay substrate.

In step S13, outputs from the detection electrodes 40, 42, 44, and 46 are measured. Specifically, signals, that is, detection vibration output from the first detection electrode 40 and the third detection electrode 44 through the charge amplifier 451, and signals, that is, detection vibration output from the second detection electrode 42 and the fourth detection electrode 46 through the charge amplifier 452 are measured.

In step S14 (second step), at least one of the drive vibration arms 220, 222, 224, and 226 is adjusted, that is, balance tuning is performed. Specifically, weight portions (not shown) serving as first weight portions provided in the wide-width portions 5 of the drive vibration arms 220 and 222 are adjusted, and weight portions (not shown) serving as second weight portions provided in the drive vibration arms 224 and 226 are adjusted (see FIG. 2).

The adjusting changes the mass of the weight portion. Specifically, for example, a gold film of about 1 μm formed in the weight portion is irradiated with an energy ray such as a laser to remove a part of the gold film. By removing the gold film, the frequency increases. A method of reducing the frequency by adding a gold film by sputtering or vapor deposition using a metal mask may be used.

In the balance tuning, the masses of the weight portions provided in the drive vibration arms 220, 222, 224, and 226 are changed and adjusted while measuring a detection signal generated by unnecessary vibration, and the unnecessary vibration is reduced. In the balance tuning, unnecessary signals generated from the two detection vibration arms 230 and 232 are separately measured, and processing amounts of the drive vibration arms 220, 222, 224, and 226 are calculated according to measurement values.

As shown in FIG. 8, an electrode that can measure the unnecessary signal is, for example, the first detection electrode 40 and the fourth detection electrode 46. By looking at laser marks (processing marks) of the drive vibration arms 220, 222, 224, and 226, it is possible to determine whether the balance tuning is performed.

Accordingly, by changing the masses of the weight portions, it is possible to adjust frequencies generated by the drive vibration arms 220, 222, 224, and 226, and it is possible to prevent an unnecessary signal from being detected by the first detection vibration arm 230 and the second detection vibration arm 232.

It is possible to provide the physical quantity detection device 400 with higher reliability by performing the balance tuning after mounting the vibration element 100 on the package or the support substrate.

By measuring the detection vibration through the charge amplifiers 451 and 452 (see FIG. 4), even a slight unnecessary signal detected by the detection electrodes 40, 42, 44, and 46 can be reliably measured.

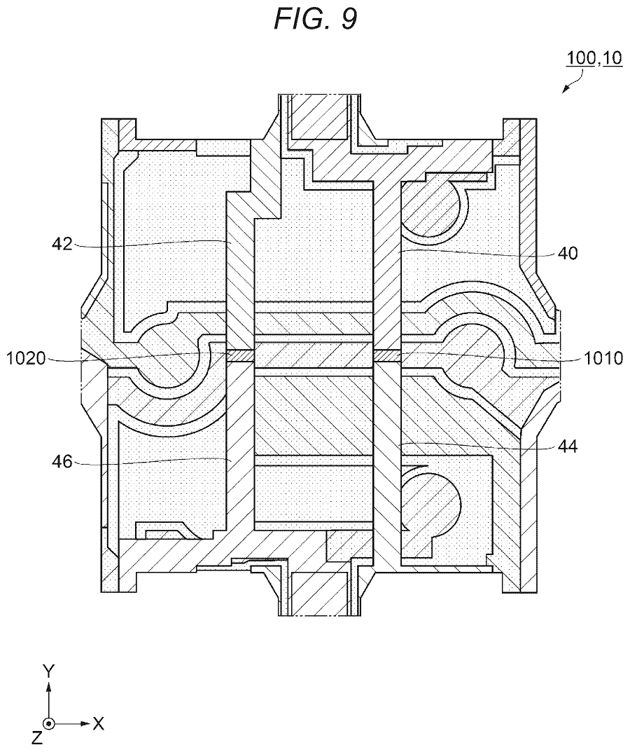

In step S15 (third step), as shown in FIG. 9, the first detection electrode 40 and the third detection electrode 44 are electrically coupled to each other, and the second detection electrode 42 and the fourth detection electrode 46 are electrically coupled to each other. Specifically, electrical coupling is performed by adding the conductive members 1010 and 1020. More specifically, the first detection electrode 40 and the third detection electrode 44 are electrically coupled to each other through the first conductive member 1010. The second detection electrode 42 and the fourth detection electrode 46 are electrically coupled to each other through the second conductive member 1020.

Examples of the coupling method include an ink jet method, a coating method, and a bonding method. The ink jet method is an electrostatic ink jet or a piezo type ink jet, and dispenses a conductive ink or a conductive paste. In the coating method, a conductive adhesive is applied. The bonding method is wire bonding or bump bonding.

Accordingly, since the third detection electrode 44 and the fourth detection electrode 46 are decoupled from both the first detection electrode 40 and the second detection electrode 42, the detection vibration of the two detection vibration arms 230 and 232 can be individually detected, in other words, can be measured. Accordingly, the adjustment, that is, the balance tuning of the drive vibration arms 220, 222, 224, and 226 can be appropriately performed. Accordingly, it is possible to prevent a variation in the performance of the physical quantity detection device 400. After performing the balance tuning, the positive electrodes and the negative electrodes are electrically coupled to each other in the detection electrodes 40, 42, 44, and 46. Therefore, it is possible to provide the physical quantity detection device 400 capable of improving the sensitivity of the vibration characteristic.

As described above, the method of manufacturing the physical quantity detection device 400 according to the embodiment is a method of manufacturing the physical quantity detection device 400 including: the vibration element 100 including the base portion 10 and a plurality of vibration arms 220, 222, 224, 226, 230, and 232 coupled to the base portion 10; the detection circuit 450 that detects the detection vibration generated in the vibration element 100; and the drive circuit 440 that drives the vibration arms 220, 222, 224, 226, 230, and 232 to vibrate. The vibration arms 220, 222, 224, 226, 230, and 232 include: the drive vibration arms 220 and 222 each having a weight portion at a tip end; the drive vibration arms 224 and 226 each having a weight portion at a tip end; the first detection vibration arm 230 including the first detection electrode 40 and the second detection electrode 42; and the second detection vibration arm 232 including the third detection electrode 44, which is decoupled from both the first detection electrode 40 and the second detection electrode 42, and the fourth detection electrode 46 decoupled from both the first detection electrode 40 and the second detection electrode 42. The method includes: preparing the vibration element 100; adjusting at least one of the drive vibration arms 220, 222, 224, and 226; and electrically coupling the first detection electrode 40 and the third detection electrode 44, and electrically coupling the second detection electrode 42 and the fourth detection electrode 46.

According to the method, since the third detection electrode 44 and the fourth detection electrode 46 are decoupled from both the first detection electrode 40 and the second detection electrode 42, the detection vibration of the two detection vibration arms 230 and 232 can be individually detected, in other words, can be measured. Accordingly, the adjustment, that is, the balance tuning of the drive vibration arms 220, 222, 224, and 226 can be appropriately performed. Accordingly, it is possible to prevent a variation in the performance of the physical quantity detection device 400.

In the method of manufacturing the physical quantity detection device 400 according to the embodiment, the adjusting may change a mass of at least one weight portion. According to the method, by changing the masses of the weight portions, it is possible to adjust frequencies generated by the drive vibration arms 220, 222, 224, and 226, and it is possible to prevent an unnecessary signal from being detected by the first detection vibration arm 230 and the second detection vibration arm 232.

In the method of manufacturing the physical quantity detection device 400 according to the embodiment, the physical quantity detection device 400 may include the charge amplifier 451 as the first amplifier, to which outputs from the first detection electrode 40 and the third detection electrode 44 are input, and the charge amplifier 452 as the second amplifier to which outputs from the second detection electrode 42 and the fourth detection electrode 46 are input, and the detection vibration may be measured through the charge amplifiers 451 and 452 before the second step. According to this method, by measuring the detection vibration through the charge amplifiers 451 and 452, even a slight unnecessary signal detected by the detection electrodes 40, 42, 44, and 46 can be reliably measured.

In the method of manufacturing the physical quantity detection device 400 according to the embodiment, the second step may be performed after the vibration element 100 is mounted on the package or the support substrate. According to the method, it is possible to provide the physical quantity detection device 400 with higher reliability by performing the balance tuning after mounting the vibration element 100 on the package or the support substrate.

In the method of manufacturing the physical quantity detection device 400 according to the embodiment, in the third step, electrical coupling may be performed by adding the conductive members 1010 and 1020. According to the method, after performing the balance tuning, the first detection electrode 40 and the third detection electrode 44 are electrically coupled to each other, and the second detection electrode 42 and the fourth detection electrode 46 are electrically coupled to each other, that is, the positive electrodes are electrically coupled to each other and the negative electrodes are electrically coupled to each other. Therefore, it is possible to provide the physical quantity detection device 400 capable of improving the sensitivity of the vibration characteristic.

In the method of manufacturing the physical quantity detection device 400 according to the embodiment, the vibration element 100 may be a double T-type gyro sensor element. According to the method, it is possible to provide the physical quantity detection device 400 including the double T-type gyro sensor element capable of improving the vibration characteristic.

The physical quantity detection device 400 according to the embodiment includes: the vibration element 100 including the base portion 10 and the plurality of vibration arms 220, 222, 224, 226, 230, and 232 coupled to the base portion 10; the detection circuit 450 that detects the detection vibration generated in the vibration element 100; and the drive circuit 440 that drives the vibration arms 220, 222, 224, 226, 230, and 232 to vibrate. The vibration arms 220, 222, 224, 226, 230, and 232 include: the drive vibration arms 220, 222, 224, and 226 each having a weight portion at a tip end; the first detection vibration arm 230 including the first detection electrode 40 and the second detection electrode 42; and the second detection vibration arm 232 including the third detection electrode 44 and the fourth detection electrode 46. The first detection electrode 40 and the third detection electrode 44 are electrically coupled to each other by the first conductive member 1010. The second detection electrode 42 and the fourth detection electrode 46 are electrically coupled to each other by the second conductive member 1020. At least one of the weight portions is formed with a processing mark recessed in the thickness direction.

According to this configuration, the processing mark recessed in the weight portion is formed, and the detection electrodes 40, 42, 44, and 46 are coupled to each other by the first conductive member 1010 and the second conductive member 1020. Therefore, the adjustment, that is, the balance tuning of the drive vibration arms 220, 222, 224, and 226 can be performed, and the sensitivity of the detection vibration arms 230 and 232 can be improved. That is, it is possible to prevent a variation in the performance of the physical quantity detection device 400, and improve the vibration characteristic. By the processing marks of the weight portions at the tip ends of the drive vibration arms 220, 222, 224, and 226, it is also possible to confirm that the balance tuning is performed.

A modification of the above embodiment will be described below.

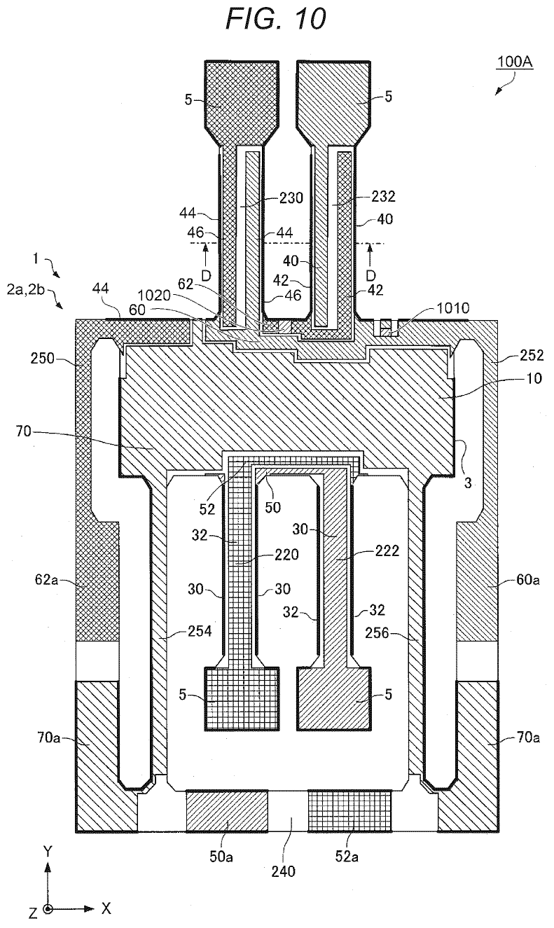

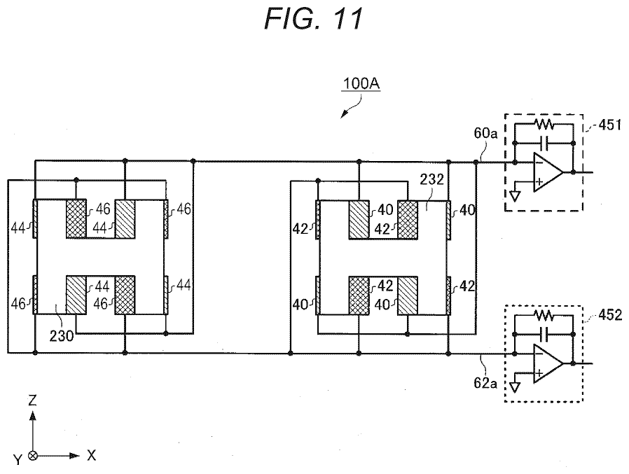

As described above, the vibrator element 1 is not limited to a double T-type gyro sensor, and may be an H-type gyro sensor. Hereinafter, a configuration of a gyro sensor according to a modification will be described with reference to FIGS. 10 and 11. FIG. 10 is a diagram of a vibration element 100A according to the modification as viewed from the first principal surface 2a side. FIG. 11 also shows a coupling relationship between the vibration element 100 and the charge amplifiers 451 and 452. In FIGS. 10 and 11, members having the same functions as those of the vibration element 100 according to the above embodiment are denoted by the same reference signs, and detailed description thereof is omitted.

As shown in FIG. 10, the vibration element 100A according to the modification includes the base portion 10, the drive vibration arms 220 and 222, the detection vibration arms 230 and 232, the support portion 240, and the beam portions 250, 252, 254, and 256.

The first detection electrode 40 is provided at the second detection vibration arm 232. In the illustrated example, the first detection electrode 40 is provided at the principal surfaces 2a and 2b and the side surface 3 of the second detection vibration arm 232.

The second detection electrode 42 is provided at the second detection vibration arm 232. In the illustrated example, the second detection electrode 42 is provided at the principal surfaces 2a and 2b and the side surface 3 of the second detection vibration arm 232.

The third detection electrode 44 is provided at the first detection vibration arm 230. In the illustrated example, the third detection electrode 44 is provided at the principal surfaces 2a and 2b and the side surface 3 of the first detection vibration arm 230.

The fourth detection electrode 46 is provided at the first detection vibration arm 230. In the illustrated example, the fourth detection electrode 46 is provided at the principal surfaces 2a and 2b and the side surface 3 of the first detection vibration arm 230.

In the embodiment, as shown in FIG. 11, groove portions are provided in the principal surfaces 2a of the vibration arms 230 and 232. Cross sections of the vibration arms 230 and 232 are H-shaped. The electrodes 40, 42, 44, and 46 are provided in the groove portions and the side surface 3. Although not shown, the principal surfaces 2a of the vibration arms 220 and 222 may be provided with groove portions, and the electrodes 30 and 32 may be provided in the groove portions.

In the vibration element 100A, the outputs from the detection electrodes 40, 42, 44, and 46 are also measured, and the balance tuning of the drive vibration arms 220 and 222 is performed based on the measured signals. Thereafter, the first detection electrode 40 and the third detection electrode 44 are electrically coupled to each other through the first conductive member 1010, and the second detection electrode 42 and the fourth detection electrode 46 are electrically coupled to each other through the second conductive member 1020. Accordingly, the sensitivity of the vibration characteristic can be improved.

As described above, in a method of manufacturing the physical quantity detection device 400 according to the modification, the vibration element 100 may be an H-type gyro sensor element. According to the method, it is possible to provide the physical quantity detection device 400 including the H-type gyro sensor element capable of improving the vibration characteristic.

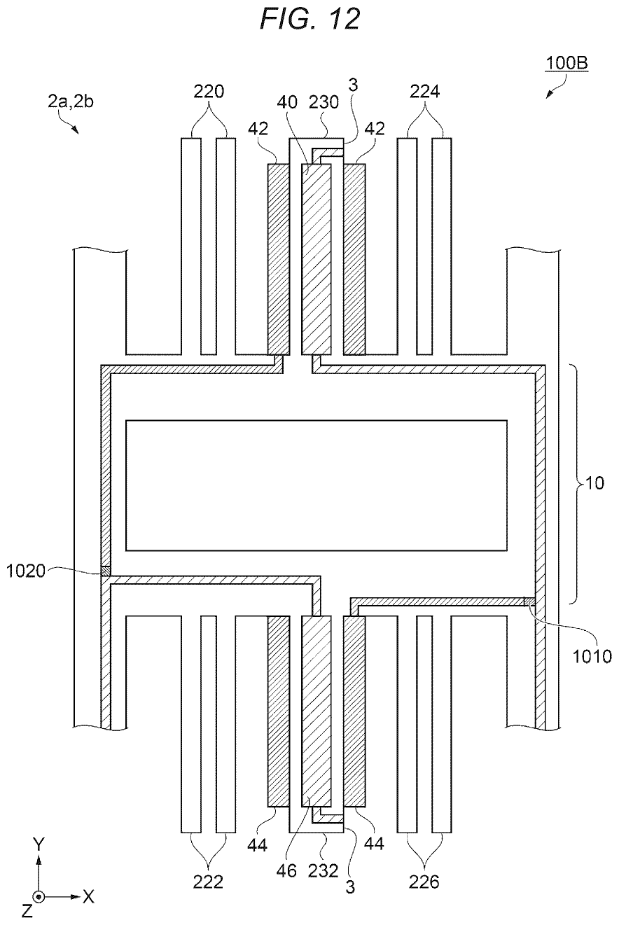

As described above, the vibrator element 1 is not limited to the double T-type gyro sensor, and may be the physical quantity detection device 400 including a vibration element 100B shown in FIG. 12.

As shown in FIG. 12, the vibration element 100B according to the modification includes the base portion 10, the drive vibration arms 220, 222, 224, and 226, and detection vibration arms 230 and 232.

The first detection electrode 40 is provided at the principal surfaces 2a and 2b of the detection vibration arm 230. The second detection electrode 42 is provided at the side surface 3 of the detection vibration arm 230.

The third detection electrode 44 is provided at the side surface 3 of the detection vibration arm 232. The fourth detection electrode 46 is provided at the principal surfaces 2a and 2b of the detection vibration arm 232.

In the vibration element 100B, the outputs from the detection electrodes 40, 42, 44, and 46 are also measured, and the balance tuning of the drive vibration arms 220, 222, 224, and 226 is performed based on the measured signals. Thereafter, the first detection electrode 40 and the third detection electrode 44 are electrically coupled to each other through the first conductive member 1010, and the second detection electrode 42 and the fourth detection electrode 46 are electrically coupled to each other through the second conductive member 1020. Accordingly, the sensitivity of the vibration characteristic can be improved.

As described above, the double T-type gyro sensor or the H-type gyro sensor is exemplified as the vibration element 100 and is not limited to this, and may be a silicon MEMS gyro sensor. The vibration element 100 is not limited to the gyro element, and may be, for example, a tuning fork type vibration element.

What is claimed is:

1. A method of manufacturing a physical quantity detection device
the physical quantity detection device including
a physical quantity detection element including a base portion and a plurality of vibration arms coupled to the base portion,
a detection circuit configured to detect detection vibration generated in the physical quantity detection element, and
a drive circuit configured to drive the vibration arms to vibrate,
the vibration arms including
a first drive vibration arm having a first weight portion at a tip end,
a second drive vibration arm having a second weight portion at a tip end,
a first detection vibration arm including a first detection electrode and a second detection electrode, and
a second detection vibration arm including a third detection electrode decoupled from both the first detection electrode and the second detection electrode, and a fourth detection electrode decoupled from both the first detection electrode and the second detection electrode,
the method comprising:
preparing the physical quantity detection element;
adjusting at least one of the first drive vibration arm and the second drive vibration arm; and
electrically coupling the first detection electrode and the third detection electrode and electrically coupling the second detection electrode and the fourth detection electrode.

2. The method of manufacturing a physical quantity detection device according to claim 1, wherein
the adjusting changes a mass of at least one of the first weight portion and the second weight portion.

3. The method of manufacturing a physical quantity detection device according to claim 1, wherein
the physical quantity detection device further includes
a first amplifier to which outputs from the first detection electrode and the third detection electrode are input, and
a second amplifier to which outputs from the second detection electrode and the fourth detection electrode are input, and
the detection vibration is measured through the first amplifier and the second amplifier before the second step.

4. The method of manufacturing a physical quantity detection device according to claim 1, wherein
the second step is performed after the physical quantity detection element is mounted on a package or a support substrate.

5. The method of manufacturing a physical quantity detection device according to claim 1, wherein
in the third step, electrical coupling is performed by adding a conductive member.

6. The method of manufacturing a physical quantity detection device according to claim 1, wherein
the physical quantity detection element is a double T-type gyro sensor element.

7. The method of manufacturing a physical quantity detection device according to claim 1, wherein
the physical quantity detection element is an H-type gyro sensor element.

8. A physical quantity detection device comprising:
a physical quantity detection element including a base portion and a plurality of vibration arms coupled to the base portion;
a detection circuit configured to detect detection vibration generated in the physical quantity detection element; and
a drive circuit configured to drive the vibration arms to vibrate, wherein
the vibration arms includes
a first drive vibration arm having a first weight portion at a tip end,
a second drive vibration arm having a second weight portion at a tip end,
a first detection vibration arm: including a first detection electrode and a second detection electrode, and
a second detection vibration arm including a third detection electrode and a fourth detection electrode,
the first detection electrode and the third detection electrode are electrically coupled to each other by a first conductive member,
the second detection electrode and the fourth detection electrode are electrically coupled to each other by a second conductive member, and
at least one of the first weight portion and the second weight portion is formed with a processing mark recessed in a thickness direction.
